(19) United States
(12) Patent Application Publication
(10) Pub. No.: US 2013/0322646 A1
(43) Pub. Date: Dec. 5, 2013

(54) Mintiurization Rotational Switch Actuation

(71) Applicants: Sean N. Davie, Lawrenceville, GA (US); William C. Phelps, III, Lawrenceville, GA (US)

(72) Inventors: Sean N. Davie, Lawrenceville, GA (US); William C. Phelps, III, Lawrenceville, GA (US)

(73) Assignee: MOTOROLA MOBILITY, INC., Libertyville, IL (US)

(21) Appl. No.: 13/489,126

(22) Filed: Jun. 5, 2012

(51) Int. Cl. H04R 1/10

(52) U.S. Cl. 381/74

(57) ABSTRACT

An improved wireless headset assembly 102 can be provided for wireless communications with an electronic communications device 104. The wireless headset assembly can comprise a boom 112 which pivots about an ear stem 108 of a shaft 106 for moving an earpiece 110 from a closed compact position to an open use position and vice versa. A power tact switch 114 can activate the wireless headset assembly when the earpiece is moved to the open use position and can deactivate power in the wireless headset assembly when the earpiece is moved to the closed compact position. A sensing switch 116 can be operatively connected to the ear stem for detecting the position and direction of the earpiece.

### BACKGROUND OF THE INVENTION

### Field of the Disclosure

The disclosure relates in general to communication devices and, more particularly, to a headset.

Over the years various types of wired and wireless headsets, earsets and headphones with single or dual earplugs or earbuds have been developed for communications and for use with various electronic equipment. Such conventional headsets, earsets and headphones have met with varying degrees of success but have often been cumbersome, awkward, bulky, flimsy, unreliable and of poor audio quality.

It is, therefore, desirable to provide an improved headset, which overcomes most, if not all of the preceding disadvantages.

Furthermore, it is desirable to provide an improved headset which eliminates a dedicated power button and incorporates power activation features within a rotating ear stem.

Moreover, it is desirable to provide an improved compact headset with features that can detect left and right ear positions with rotation.

### SUMMARY OF THE INVENTION

A novel wireless communications device assembly comprising an improved wireless headset is provided which is compact, sturdy, and easy to use, has superb performance and is reliable. The user friendly communications device and wireless headset are effective, economical and has excellent audio quality. Advantageously, the improved wireless headset eliminates a dedicated power button and incorporates power activation features within a rotating ear stem. Desirably, the improved compact wireless headset can include sensors that can detect left and right ear positions upon rotation of the ear stem. Also, the improved wireless headset provides competitive advantages as an ease of use differentiator.

The improved wireless headset can incorporate micro tact switches on a stationery printed circuit board (PCB) which can be mounted vertically in the middle of the ear stem such that when the ear stem is rotated, camming features on the inner surface of the ear stem activate and deactivate the switches to detect power and direction.

Among the many unique features of the improved wireless headset is the incorporation of all switching mechanisms and elements that can be incorporated within the shaft or ear stem of the headset. The headset can have a single earpiece or can have left and right earpieces.

Advantageously, momentary contact switches can be used to sense the position of the earbud or other earpiece as well as to energize the circuit of the wireless headset. Another switch can be mounted in the rotating stem of the device to sense left or right ear usage.

The improved wireless headset can eliminate a dedicated power button by incorporating the power activation features within a rotating ear stem. In addition to toggling power, small momentary tact switches solve an engineering space problem to detect left and right ear position with rotation.

The improved wireless headset can incorporate a power switch into the mechanism that readies the device for use. Advantageously, in the novel wireless headset positioning, moving or pivoting of the earbud or other earpiece, to an open use position can energize the wireless headset. Desirably, the wireless headset comprises a moving member that contains the speaker and subsequently controls the function of the device.

In one preferred embodiment, the novel wireless communications device comprises an improved wireless headset assembly for wireless communications. The unique wireless headset assembly can comprise: a rotatable shaft providing an ear stem; a boom for pivoting about the shaft to move an earpiece from a closed compact position to an open use position; and a power switch operatively associated with the ear stem for activating, energizing and powering the wireless headset assembly in response to movement of the earpiece to the open use position.

In the preferred embodiment of the wireless headset assembly, the power switch can comprise a tact switch and the sensing switch can comprise a sensor which is operatively associated with the ear stem for detecting the position of the earpiece.

In the illustrative embodiment, the wireless headset assembly includes a printed circuit board (PCB) positioned in proximity to the ear stem, and the power switch comprises a micro tact switch operatively connected and mounted on the PCB. The power switch can further comprise an off switch for deenergizing and deactivating power in the wireless communications device when the earpiece is moved to a closed compact position. A housing can be positioned about the ear stem. The housing can have a cam rib and the ear stem can comprise an ear stem-rib. The cam rib can push against and cammingly engage the ear stem-rib for activating the power switch when the earpiece is moved to the open use position.

The wireless headset assembly can comprise: a wireless earset assembly, wireless earbud assembly, wireless earplug assembly, wireless earpiece assembly, wireless headphone assembly, or combinations of any of the preceding. The wireless headset assembly can have one or more earpieces. Each earpiece can comprise an earset, earbud, or earplug. The earpiece can comprise and define an audio port providing a speaker.

Advantageously, the wireless headset assembly can communicate with an electronic communications device, such as: a portable electronic communications device; radiotelephone, cellular (cell) phone, mobile phone, smart phone, flip phone, slider phone, qwerty phone, android phone, tablet phone, camera phone, clamshell device, portable networking device, wireless device, portable gaming device, mobile communications device, personal digital assistant (PDA), wireless e-mail device, two way pager, internet communication device, android tablet, ipod, ipad, kindle, electronic reading device, blackberry, tablet device, computer, netbook, wireless device, fitness tracker, exercise monitor, sports monitor, activity tracker distance tracker, time tracker, speed tracker, calorie monitor, blood pressure monitor, heart rate monitor, health monitor, sleep tracker, handset, global positioning system (GPS), navigation device, transmitting device, electronic receiving device, electronic planner, workout planner, electronic calendar, scheduling device, music player, MP3 player, performance monitor, golf tracker, golf monitor, scoring tracker, virtual caddie, club tracking device, electronic data storage device, electronic information storage device, cadence sensor, goal setting device, electronic workout frequency reminder, workout frequency monitor, downloadable device, computer-compatible device, Bluetooth compatible device, headphone-compatible device, cell phone-compatible device, android phone-compatible device, pairing device, electronic data sharing device, or combinations of any of the preceding.

A more detailed explanation of the invention is provided in the following detailed descriptions and appended claims taken in conjunction with the accompanying drawings.

### BRIEF DESCRIPTION OF THE DRAWINGS

FIG. 1 is an enlarged perspective view of part of a wireless headset with portions removed to view interior tact switches and other components of the wireless headset in accordance with principle of the present invention.

FIG. 2 is a view similar to FIG. 1 but also showing an enlarged perspective view of the tact switches to activate, power-off and sense the left and right directions of the earpiece.

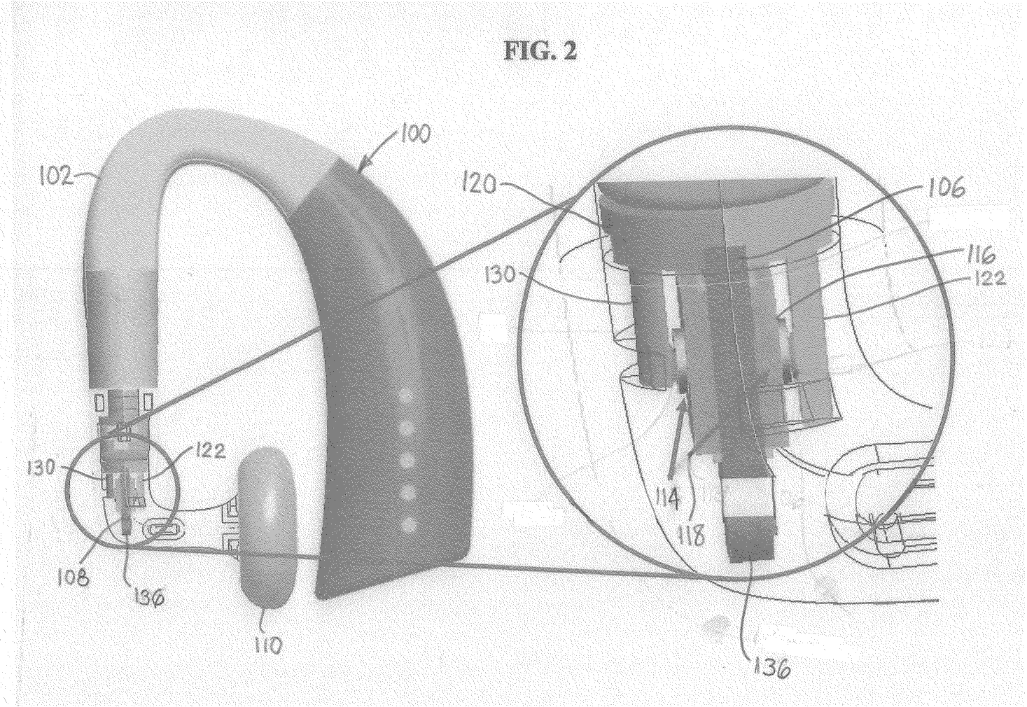

FIG. 3 is an enlarged view of a left-mode rib and off-mode rib of the wireless headset.

FIG. 4 is an enlarged perspective interior view of part of a wireless headset in an off mode.

FIG. 5 is a greatly enlarged interior view of part of the power-off tact switch and left-mode sensing tact switch in the off mode.

FIG. 6 is a perspective view of part of the wireless headset in a left mode and illustrating an enlarged interior view of the earpiece, tact switches and other components of the headset.

FIG. 7 is a greatly enlarged interior view of part of the power tact switch and left-mode sensing tact switch in the left mode and illustrating the cam rib on the housing pushing against the ear stem rib to activate the left-mode tact switch.

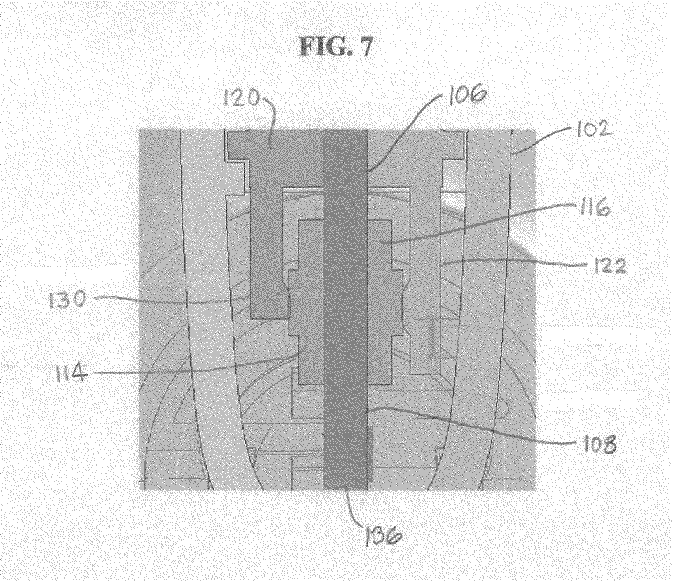

FIG. 8 is an enlarged interior perspective view of part of the wireless headset and illustrating the tact switches and ribs.

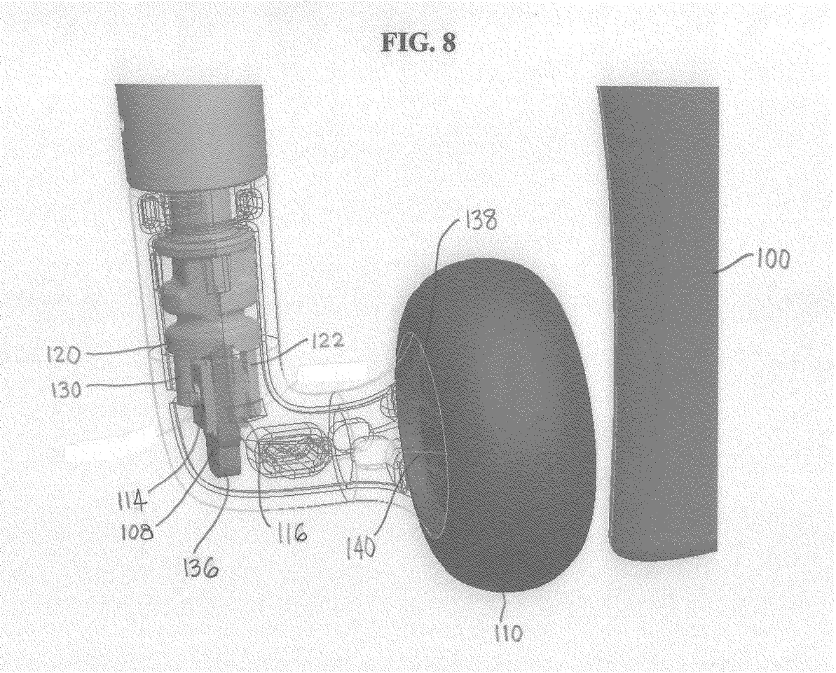

FIG. 9 is an enlarged cross-sectional view of the wireless head set in the left mode when the power tact switch is not pressed.

FIG. 10 is an enlarged cross-sectional view of the wireless head set in the off mode when the power tact switch is pressed.

FIG. 11 is an enlarged cross-sectional view of the wireless head set in the right mode when the power tact switch is not pressed.

FIG. 12 is an enlarged cross-sectional view of the wireless head set in the left mode when the left-mode sensing tact switch is pressed.

FIG. 13 is an enlarged cross-sectional view of the wireless head set in the off mode when the left-mode sensing tact switch is not pressed.

FIG. 14 is an enlarged cross-sectional view of the wireless head set in the right mode when the left-mode sensing tact switch is not pressed.

FIG. 15 is an enlarged cross-sectional view of the wireless head set in the left mode without left or right mode detection when the power tact switch is not pressed.

FIG. 16 is an enlarged cross-sectional view of the wireless head set in the off mode without left or right mode detection when the power tact switch is pressed.

FIG. 17 is an enlarged cross-sectional view of the wireless head set in the right mode without left or right mode detection when the power tact switch is not pressed.

FIG. 18 is an enlarged interior view of the tact switches and other components of the wireless headset.

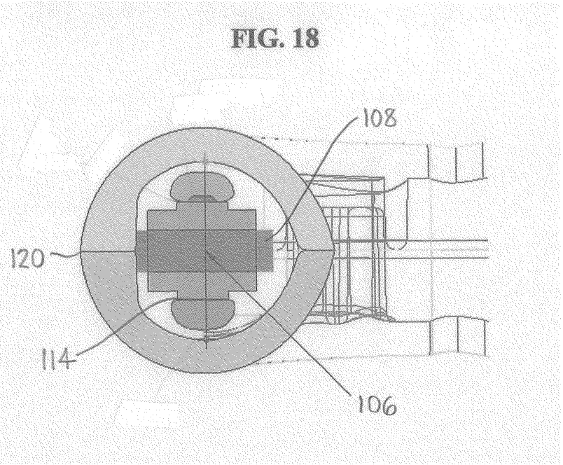

FIG. 19 is a perspective view of an electronic communications device.

### DETAILED DESCRIPTION OF THE INVENTION

The following is a detailed description and explanation of the preferred embodiments of the invention and best modes for practicing the invention.

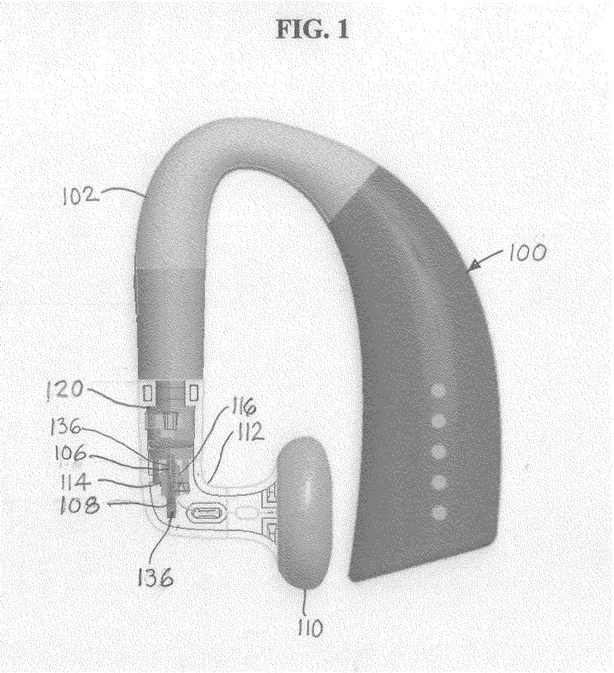

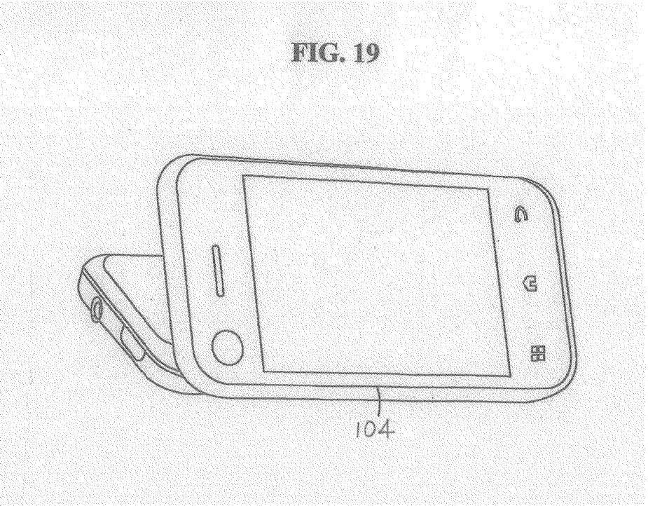

Referring to the drawings, a wireless communications device 100 comprising a wireless headset assembly 102, also referred to as a wireless headset, can be provided for wireless communications with a portable electronic communications device 104 (FIG. 19). The wireless headset can comprise at least one rotatable elongated shaft 106 (FIG. 1) providing a least one ear stem 108 and at least one earpiece 110 operatively connected to a boom 112. The boom can pivot about the ear stem of the shaft for moving the earpiece from a closed compact position to an open left use position in the left direction and to an open right use position in the right direction and vice versa. Advantageously, a power tact switch 114 providing a power-on tact switch can be operatively associated with and connected to a printed circuit board (PCB) 136 in the ear stem for activating, energizing and powering the wireless headset assembly when the earpiece is moved to one of the open use positions. The power tact switch can comprise a power-off tact switch for deactivating and turning off the power in the wireless communications device and wireless headset assembly when the earpiece is moved to the closed compact position. Sensing tact switch 116 comprising a left-mode sensor can be operatively associated and connected with the ear stem and the power tact switch for sensing and detecting the position and direction of the earpiece. The right mode is activated by default when the unit is powered on and the left mode switch is not activated.

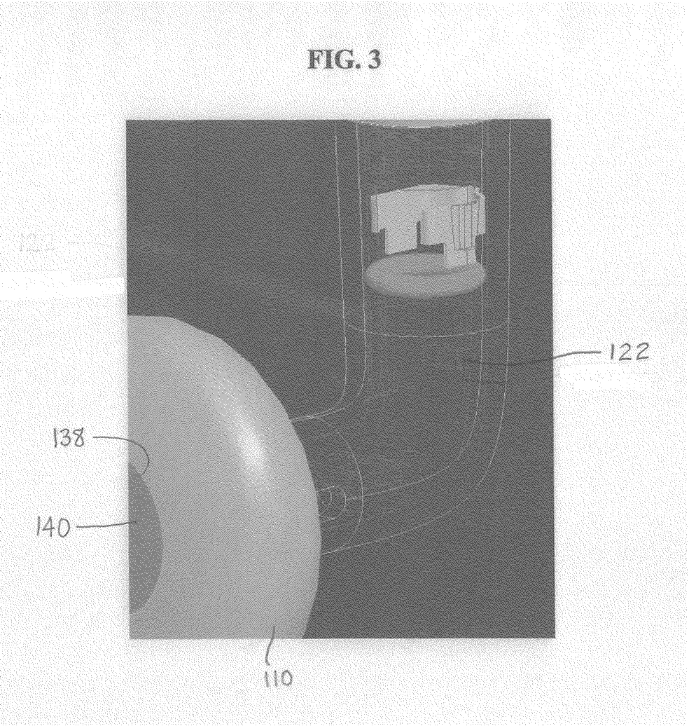

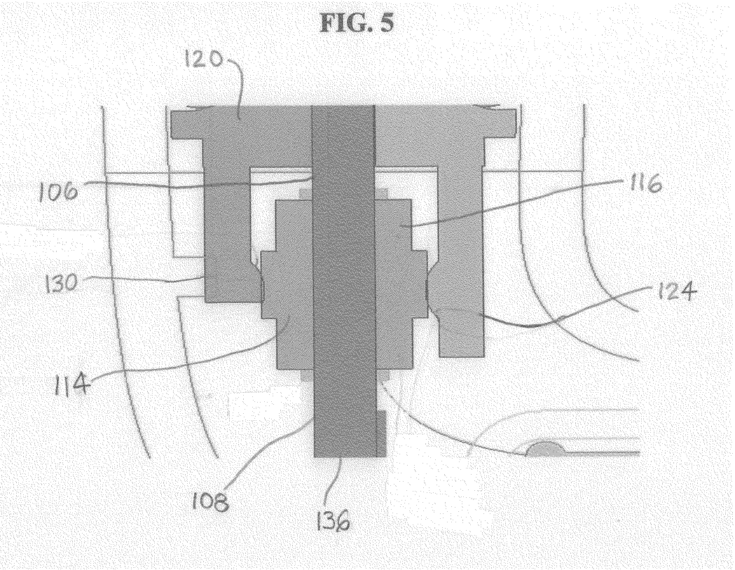

The wireless headset assembly can comprise an ear stem-housing 120 positioned about and at least partially enclosing the ear stem. The housing can have a power-mode cam rib 122 (FIG. 3), a left-mode rib 124 (FIG. 5) and a power-on tact switch rib 130 (FIG. 5) comprising an off-mode rib. The ear stem can have an ear stem-rib.

The headset power is off when the power-mode cam rib deflects the power-on tact switch rib. As soon as the power-on tact switch is released (no longer pressed), the headset powers on. When the headset powers on, it will be open in the right-mode configuration unless the left-mode tact switch is activated.

The wireless headset assembly can have a printed circuit board (PCB) 136 (FIG. 5) positioned adjacent and in proximity to the ear stem and the power switch can comprise a micro power-on tact switch operatively connected to and mounted on the PCB. The micro tact switch can further comprise a micro power-off tact switch for deactivating, powering down and turning off power in the wireless communications device when the earpiece is moved to the closed compact position. In the illustrative embodiment, the wireless headset can incorporate micro tact switches on a stationery PCB which can be mounted vertically in the middle of the ear stem such that when the ear stem is rotated, camming features on the inner surface of the ear stem activate and deactivate the switches to detect power and direction.

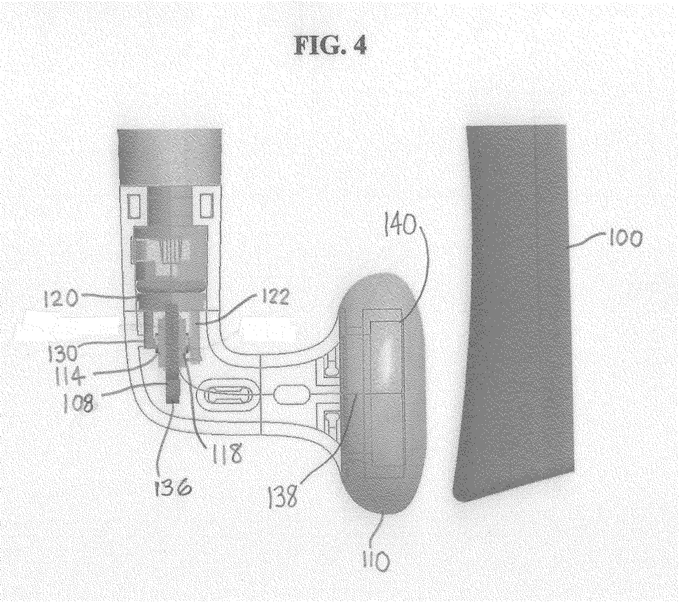

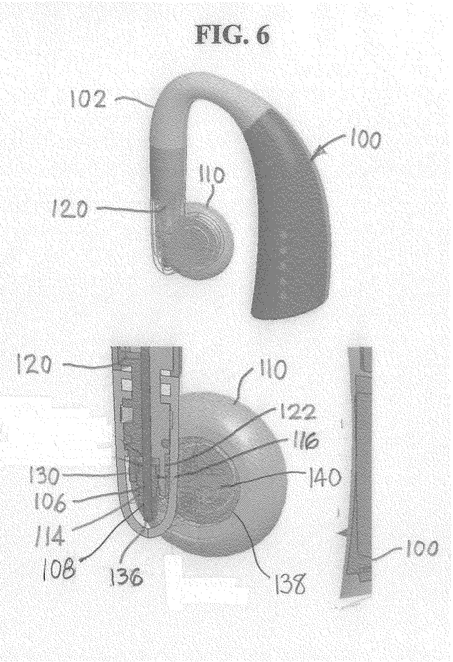

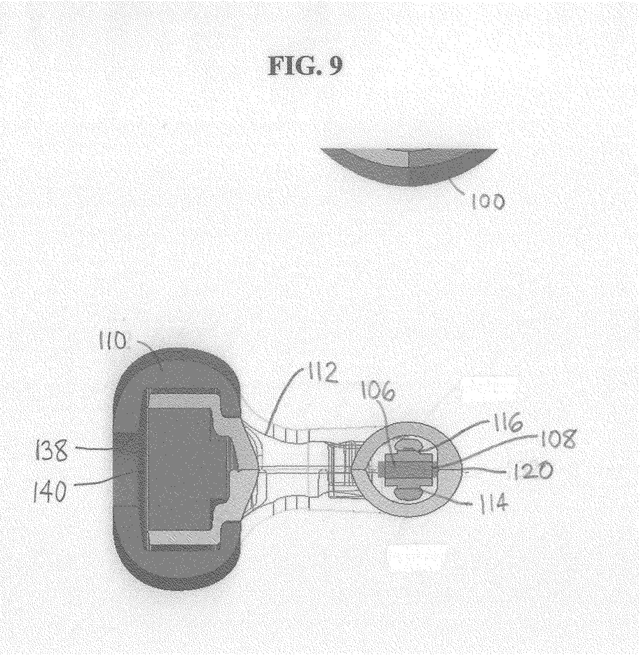

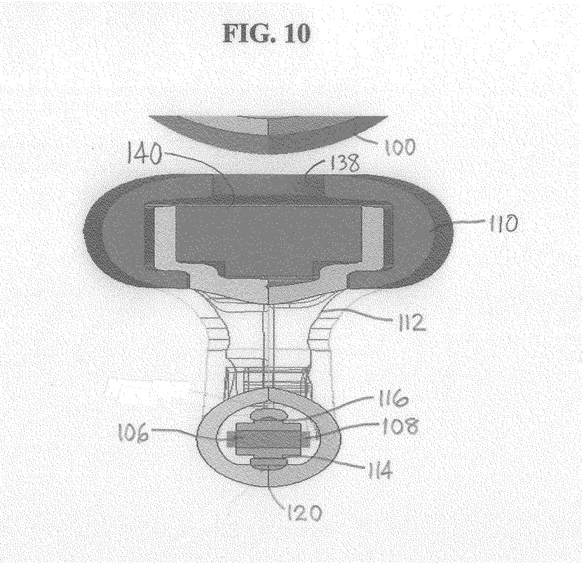

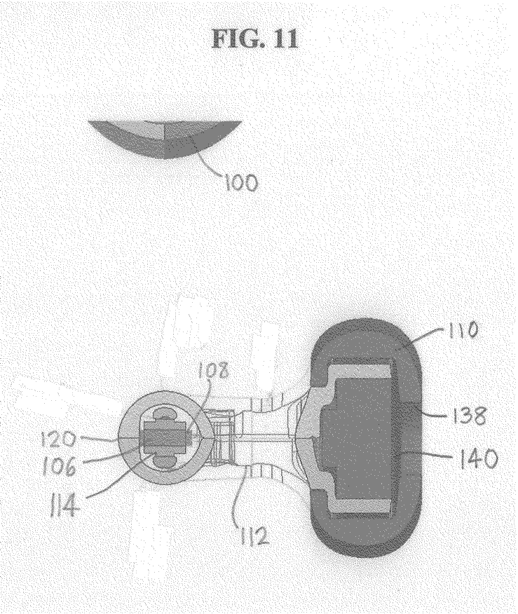

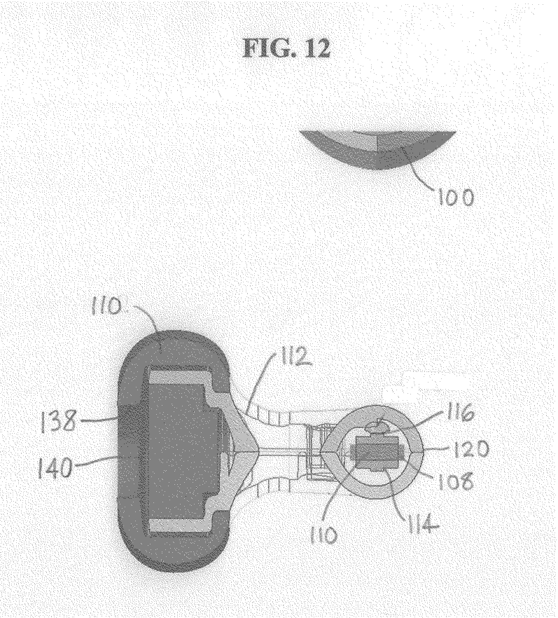

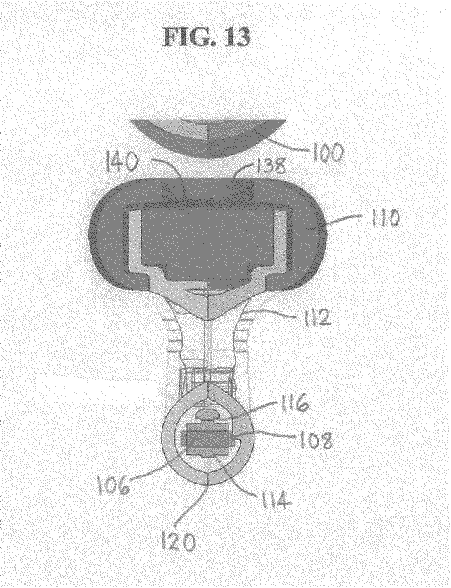

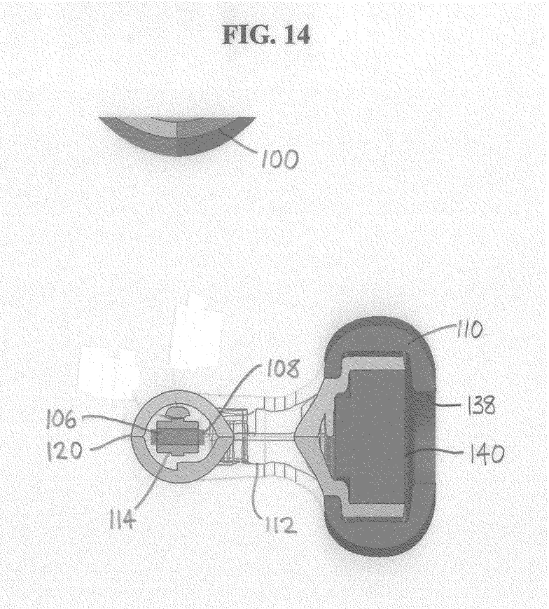

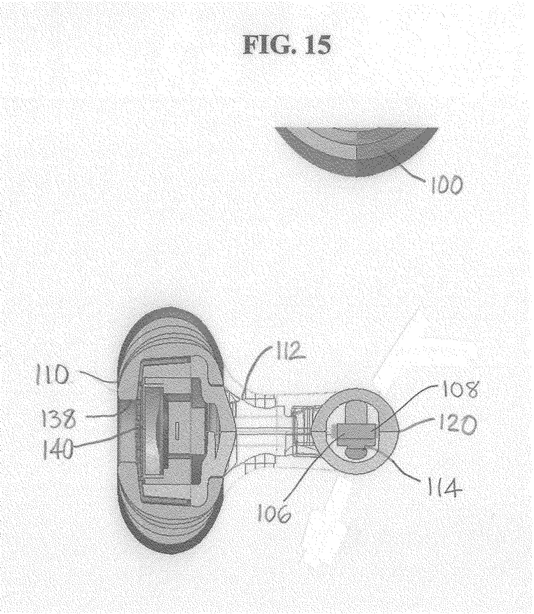

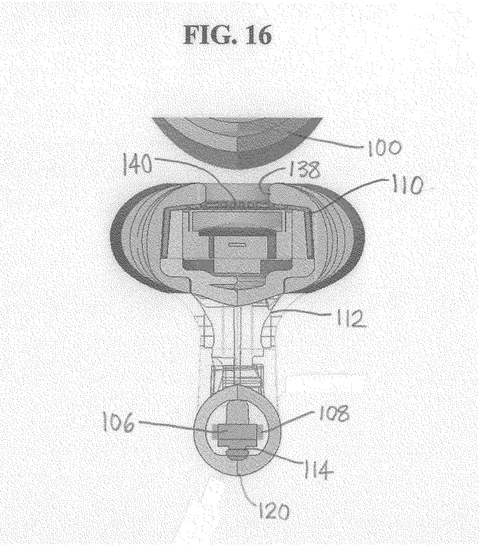

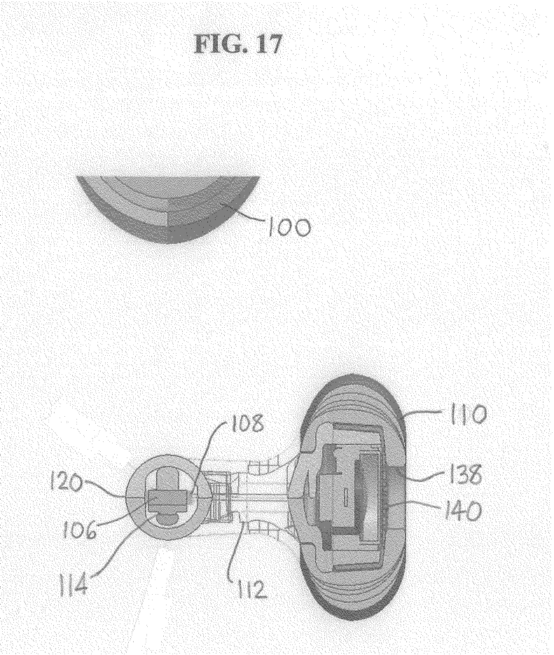

The earpiece can comprise and define an audio port 138 (FIGS. 4, 6 and 9-17) and provide a speaker 140. The earpiece can further comprise an earset, earbud, or earplug. The wireless headset assembly can comprise: a wireless earset assembly, wireless earbud assembly, wireless earplug assembly, a wireless earpiece assembly, wireless headphone assembly, or combinations of any of the preceding assemblies.

The portable electronic communications devices can comprise: a radiotelephone, cellular (cell) phone, mobile phone, smart phone, flip phone, slider phone, qwerty phone, android phone, tablet phone, camera phone, clamshell device, portable networking device, wireless device, portable gaming device, mobile communications device, personal digital assistant (PDA), wireless e-mail device, two way pager, internet communication device, android tablet, ipod, ipad, kindle, electronic reading device, blackberry, tablet device, computer, netbook, wireless device, fitness tracker, exercise monitor, sports monitor, activity tracker distance tracker, time tracker, speed tracker, calorie monitor, blood pressure monitor, heart rate monitor, health monitor, sleep tracker, handset, global positioning system (GPS), navigation device, transmitting device, electronic receiving device, electronic planner, workout planner, electronic calendar, scheduling device, music player, MP3 player, performance monitor, golf tracker, golf monitor, scoring tracker, virtual caddie, club tracking device, electronic data storage device, electronic information storage device, cadence sensor, goal setting device, electronic workout frequency reminder, workout frequency monitor, downloadable device, computer-compatible device, Bluetooth compatible device, headphone-compatible device, cell phone-compatible device, android phone-compatible device, pairing device, electronic data sharing device, or combinations of any of the preceding.

Among the many advantages of the wireless headset assembly are:

1. Superior capability.

2. Superb performance.

3. Outstanding ability to detect the orientation, position and mode of the earpiece.

4. Excellent audio quality.

5. Compact.

6. Dependable.

7. Comfortable.

8. Portable.

9. User friendly.

10. Easy to use.

11. Durable.

12. Safe.

13. Light weight.

14. Economical.

15. Attractive.

16. Efficient.

17. Effective.

Although embodiments of the invention have been shown and described, it is to be understood that various modifications, substitutions, and rearrangements of parts, components, and/or process (method) steps, as well as other uses of the wireless headset assembly and electronic communications device can be made by those skilled in the art without departing from the novel spirit and scope of this invention.

What is claimed is:

1. A wireless communications device, comprising:
a wireless headset assembly for wireless communications and comprising
a rotatable shaft providing an ear stem;
an earpiece;
a boom for pivoting about said shaft for moving said earpiece from a closed compact position to an open use position; and
a power switch operatively associated with said ear stem for powering said wireless headset assembly in response to movement of said earpiece to the open use position.

2. A wireless communications device in accordance with claim 1 including a sensing switch comprising a sensor operatively associated with said ear stem for detecting the position of said earpiece.

3. A wireless communications device in accordance with claim 1 wherein said power switch comprises a tact switch.

4. A wireless communications device in accordance with claim 1 including:
a printed circuit board (PCB) positioned in proximity to said ear stem; and
said power switch comprises a micro tact switch operatively connected to said PCB.

5. A wireless communications device in accordance with claim 1 wherein said power switch further comprises an off switch for deactivating power in said wireless communications device when said earpiece is moved to a closed compact position.

6. A wireless communications device in accordance with claim 1 including a housing positioned about said ear stem and said housing having a cam rib.

7. A wireless communications device in accordance with claim 1 wherein said earpiece is selected from the group consisting of: an earset, earbud, and earplug.

8. A wireless communications device in accordance with claim 1 wherein said wireless headset assembly is selected from the group consisting of: wireless earset assembly, wireless earbud assembly, wireless earplug assembly, a wireless earpiece assembly, wireless headphone assembly, and combinations of any of the preceding.

9. A wireless communications device in accordance with claim 1 wherein said earpiece defines an audio port providing a speaker.

10. A wireless communications device in accordance with claim 1 wherein:
said wireless headset assembly communicates with an electronic communications device; and
said electronic communications devices is selected from the group consisting of: a portable electronic communications device; radiotelephone, cellular (cell) phone, mobile phone, smart phone, flip phone, slider phone, qwerty phone, android phone, tablet phone, camera phone, clamshell device, portable networking device, wireless device, portable gaming device, mobile communications device, personal digital assistant (PDA), wireless e-mail device, two way pager, internet communication device, android tablet, ipod, ipad, kindle, electronic reading device, blackberry, tablet device, computer, netbook, wireless device, fitness tracker, exercise monitor, sports monitor, activity tracker distance tracker, time tracker, speed tracker, calorie monitor, blood pressure monitor, heart rate monitor, health monitor, sleep tracker, handset, global positioning system (GPS), navigation device, transmitting device, electronic receiving device, electronic planner, workout planner, electronic calendar, scheduling device, music player, MP3 player, performance monitor, golf tracker, golf monitor, scoring tracker, virtual caddie, club tracking device, electronic data storage device, electronic information storage device, cadence sensor, goal setting device, electronic workout frequency reminder, workout frequency monitor, downloadable device, computer-compatible device, Bluetooth compatible device, headphone-compatible device, cell phone-compatible device, android phone-compatible device, pairing device, electronic data sharing device, and combinations of any of the preceding.

11. A wireless communications device, comprising:
a wireless headset assembly for wireless communications and comprising
a rotatable elongated shaft providing an ear stem;
an earpiece;
a boom for pivoting about said shaft for moving said earpiece from a closed compact position to an open left use position in the left direction and to an open right use position in the right direction and vice versa; and
a power switch providing a power-on switch operatively associated with said ear stem for activating said wireless headset assembly in response to movement of said earpiece to one of said open use positions.

12. A wireless communications device in accordance with claim 11 including at least one sensing switch comprising a sensor operatively associated with said ear stem for detecting the position and direction of said earpiece.

13. A wireless communications device in accordance with claim 11 including:
a housing positioned about and partially enclosing said ear stem; and
said housing having a left-mode rib and an off-mode rib.

14. A wireless communications device in accordance with claim 11 including:
a printed circuit board (PCB) positioned adjacent said ear stem; and
said power switch comprises a micro tact switch mounted on said PCB; and
said micro tact switch further comprises a micro off-tact switch for deactivating power in said wireless communications device when said earpiece is moved to said closed compact position.

15. A wireless communications device in accordance with claim 11 wherein:
said earpiece defines an audio port providing a speaker, and said earpiece is selected from the group consisting of: an earset, earbud, and earplug;
said wireless headset assembly is selected from the group consisting of: a wireless earset assembly, wireless earbud assembly, wireless earplug assembly, wireless earpiece assembly, wireless headphone assembly, and combinations of any of the preceding;
said wireless headset assembly communicates with an electronic communications device; and
said electronic communications devices is selected from the group consisting of: a portable electronic communications device; radiotelephone, cellular (cell) phone, mobile phone, smart phone, flip phone, slider phone, qwerty phone, android phone, tablet phone, camera phone, clamshell device, portable networking device, wireless device, portable gaming device, mobile communications device, personal digital assistant (PDA), wireless e-mail device, two way pager, internet communication device, android tablet, ipod, ipad, kindle, electronic reading device, blackberry, tablet device, computer, netbook, wireless device, fitness tracker, exercise monitor, sports monitor, activity tracker distance tracker, time tracker, speed tracker, calorie monitor, blood pressure monitor, heart rate monitor, health monitor, sleep tracker, handset, global positioning system (GPS), navigation device, transmitting device, electronic receiving device, electronic planner, workout planner, electronic calendar, scheduling device, music player, MP3 player, performance monitor, golf tracker, golf monitor, scoring tracker, virtual caddie, club tracking device, electronic data storage device, electronic information storage device, cadence sensor, goal setting device, electronic workout frequency reminder, workout frequency monitor, downloadable device, computer-compatible device, Bluetooth compatible device, headphone-compatible device, cell phone-compatible device, android phone-compatible device, pairing device, electronic data sharing device, and combinations of any of the preceding.

16. A wireless communications device, comprising:
a wireless headset assembly for wireless communications with a portable electronics communications device; said wireless headset comprising
at least one rotatable elongated shaft providing a least one ear stem;
at least one earpiece;
at least one boom for pivoting about said ear stem of said shaft for moving said earpiece from a closed compact position to an open left use position in the left direction and to an open right use position in the right direction and vice versa; and
a power tact switch operatively associated with said ear stem for activating, energizing and powering said wireless headset assembly when said earpiece is moved to one of said open use positions and for deactivating power in said wireless communications device when said earpiece is moved to said closed compact position.

17. A wireless communications device in accordance with claim 16 including a sensing switch comprising a sensor operatively associated with said ear stem and said power tact switch for detecting the position and direction of said earpiece.

18. A wireless communications device in accordance with claim 16 including:
an ear stem-housing positioned about and at least partially enclosing said ear stem; and
said ear stem-housing having a left-mode rib and an off-mode rib.

19. A wireless communications device in accordance with claim 16 including:
a printed circuit board (PCB) positioned in proximity to said ear stem;
said power switch comprises a micro tact switch operatively connected to and mounted on said PCB.

20. A wireless communications device in accordance with claim 16 wherein:
said earpiece defines an audio port and provides a speaker, and said earpiece is selected from the group consisting of: an earset, earbud, and earplug;
said wireless headset assembly is selected from the group consisting of: a wireless earset assembly, wireless earbud assembly, wireless earplug assembly, wireless earpiece assembly, wireless headphone assembly, and combinations of any of the preceding; and
said portable electronic communications device is selected from the group consisting of: a radiotelephone, cellular (cell) phone, mobile phone, smart phone, flip phone, slider phone, qwerty phone, android phone, tablet phone, camera phone, clamshell device, portable networking device, wireless device, portable gaming device, mobile communications device, personal digital assistant (PDA), wireless e-mail device, two way pager, internet communication device, android tablet, ipod, ipad, kindle, electronic reading device, blackberry, tablet device, computer, netbook, wireless device, fitness tracker, exercise monitor, sports monitor, activity tracker distance tracker, time tracker, speed tracker, calorie monitor, blood pressure monitor, heart rate monitor, health monitor, sleep tracker, handset, global positioning system (GPS), navigation device, transmitting device, electronic receiving device, electronic planner, workout planner, electronic calendar, scheduling device, music player, MP3 player, performance monitor, golf tracker, golf monitor, scoring tracker, virtual caddie, club tracking device, electronic data storage device, electronic information storage device, cadence sensor, goal setting device, electronic workout frequency reminder, workout frequency monitor, downloadable device, computer-compatible device, Bluetooth compatible device, headphone-compatible device, cell phone-compatible device, android phone-compatible device, pairing device, electronic data sharing device, and combinations of any of the preceding.
